(19) United States
(12) Patent Application Publication
(10) Pub. No.: US 2010/0076860 A1
(43) Pub. Date: Mar. 25, 2010

(54) Online Timeshift Auctions

(76) Inventor: Edisher Kaghashvili, Nashua, NH (US)

Correspondence Address: Edisher Kaghashvili, 26 Newcastle Drive, Suite 4, Nashua, NH, 03060, US

(21) Appl. No.: 12/564,070

(22) Filed: Sep. 22, 2009

Related U.S. Application Data
(60) Provisional application No. 61/099,517, filed on Sep. 23, 2008.

(51) Int. Cl. G06Q 30/00

(52) U.S. Cl. 705/26

(57) ABSTRACT

A method for conducting online timeshift auctions is disclosed. Online timeshift auctions are slight, but qualitative modifications of the existing popular auctions where items are offered for a fixed time period. According to one embodiment, conducting a standard timeshift auction comprises the following steps: the seller sets the predetermined auction period (10), the timeshift interval (30) that determines a closing portion of the predetermined auction period (10), the starting price (12), etc. At the end of the predetermined auction period (10), the highest bidder who had placed at least a single bid before the countdown of the timeshift interval (30) started, obtains the item. Other embodiments are described and shown.

### CROSS-REFERENCE TO RELATED APPLICATIONS

This application claims benefits of provisional patent application Ser. No. 61/099,517 filed 2008 Sep. 23 by the present inventor.

### FEDERALLY SPONSORED RESEARCH

Not Applicable.

### SEQUENCE LISTING OR PROGRAM

Not Applicable.

### BACKGROUND

1. Field of Invention

This invention relates to the field of online auctions facilitated by a computer network.

2. Prior Art

Traditional live on-site auctions have a long history. In live on-site auctions, items are offered for a specified initial purchase price. People compete for an item by placing their bids. This process continues until the person, who is willing to pay the highest price, acquires the item.

In live auctions, participants of the auction are required to undergo some kind of registration. There are many forms of registrations: a simple no-cost registration, paid registration, registration when the initial deposit is required that counts toward the final purchase price, etc. An important aspect of this procedure is that the information is collected about the demand on a particular item. This is the one of the most attractive elements of the live on-site auctions. The more accurate and complete obtained information is, the more deterministic the outcome will be if the identical item is auctioned again.

The major limitation of the live on-site auctions is a number of people competing for an item. In today's economy, the e-commerce is less geographically divided and online auctions are becoming increasingly popular for buying and selling goods. Online auctions allow sellers to reach millions of customers.

In the most popular standard online auctions, such as those offered by eBay, items are offered for a fixed time period. The seller sets the starting price and the predetermined auction period. The buyers bid and drive the price up as they compete to outbid each other. The winning bid is the highest posted bid at the end of the auction. The major setback of the standard online auction is that it does not encourage potential buyers to reveal their interest early. In fact, it encourages an experienced bidder to wait until the very end of the auction and, if the price is acceptable, place the bid only a few seconds before the end of the auction; thus no other interested bidders will have the time to place a higher bid. This limitation is denoted as an optimal strategy limitation throughout this application.

There is also another factor that prevents to determine accurately a number of potential buyers in the standard online auctions. Since bidders are not encouraged to bid early, only a fraction of interested bidders will be following a closing portion, say the last 20-30 minutes of the predetermined auction period, and waiting for making a bid just before the end of the auction. Thus, there are at least two major factors that do not allow sellers to obtain the accurate information about a number of the potential buyers.

Online auctions provide a unique way for businesses to do research, market and advertise their products. An important part of every business is advertisement. Advertisement costs money. Thus, for small businesses and start-ups an optimal marketing price of a newly developed product and information about the number of potential buyers play a vital role in their success. That is why it is very important to develop the auction methods that (a) allow sellers get a fair price for their items, (b) help to obtain much needed information about the demand, and at the same time (c) are simple and easy for bidders to understand.

To achieve above mentioned goals, different types of methods of conducting online auctions have been suggested. U.S. Pat. No. 7,315,832 to Bauer et al. proposed an online auction system comprising a preliminary portion and a virtual auction portion. During the virtual auction, after the new bid received, bidders are provided with a countdown to encourage further bidding and the countdown is re-initiated after each new bid is received. The system tries to overcome the optimal strategy limitation, but makes the end of the auction uncertain.

U.S. Pat. No. 20010021923 to Atkinson et al. proposed a method of conducting an auction in at least two rounds. It is suggested to form a rule for a next consecutive auction round, conduct the first auction round, and then, conduct the second round in accordance with the application of the rule. Again, the system lacks a clear set of universal rules that will address shortcomings of the present day auctions.

U.S. Pat. No. 7,087,740 to Meyers offers a method and an apparatus for conducting an auction in which the bidding is weighted to encourage early and higher bidding. While unique, the method is not simple to understand.

### SUMMARY

In accordance with one embodiment a standard online timeshift auction comprising the following steps: (a) defining a predetermined auction period in which the auction on a particular item is to take place; (b) defining a timeshift interval which determines a closing portion of the predetermined auction period; and (c) selecting the winner of the auction at the end of the predetermined auction period to be the highest bidder who had placed at least a single bid before the countdown of the timeshift interval started. Further objects and advantages of the timeshift auctions will become apparent from a consideration of the ensuring description and the accompanying drawings. The scope of the invention, however, is limited only by the appended claims.

### DRAWINGS—FIGURES

FIG. 1A and FIG. 1B illustrate a basic conceptual difference between the existing fixed period standard online auction and the corresponding standard online timeshift auction.

FIG. 2 illustrates a conceptual diagram of the forward online timeshift auctions in accordance with one embodiment.

FIG. 3 illustrates a conceptual diagram of the reverse online timeshift auctions in accordance with another embodiment.

### DRAWINGS—REFERENCE NUMERALS

10 predetermined auction period

12 auction start time

14 auction end time

16 starting bid

18 price movement direction

20 necessary bidding period

30 timeshift interval

### DETAILED DESCRIPTION OF REFERRED EMBODIMENT

The accompanying drawings illustrate the preferred embodiments of the present invention and the underlying principles how the invention works in both forward and reverse fixed time auctions.

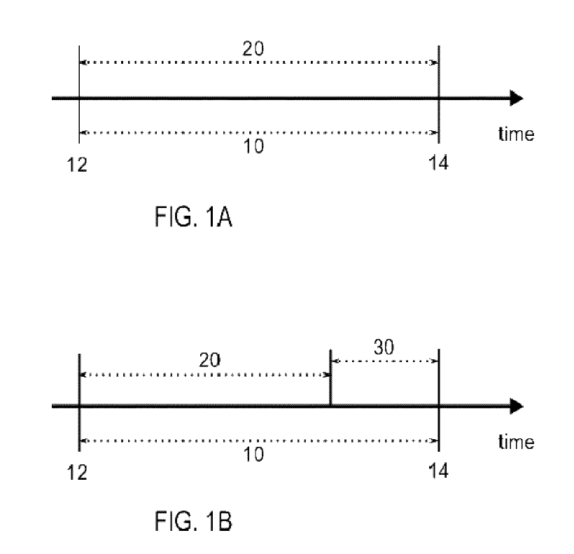

FIG. 1A and FIG. 1B illustrate a basic conceptual difference between the existing fixed period standard online auction (FIG. 1A) and the standard online timeshift auction (FIG. 1B). In the standard online auction, the seller specifies a predetermined auction period (10), which is the interval between the start of the auction (12) and the end of the auction (14). By definition, the predetermined auction period (10) is the interval when the interested buyers are allowed to place their bids. In the standard online auction shown on FIG. 1A, the predetermined auction period (10) is the same as a necessary bidding period (20), which is the interval when an eventual winner of the auction ought to had placed at least a single bid. Thus, placing at least a single bid during the necessary bidding period (20) is a requirement for all bidders who are interested in obtaining the auctioned item. As said, there is no difference between the predetermined auction period (10) and the necessary bidding period (20) in the existing standard online auction.

In the corresponding standard online timeshift auction (FIG. 1B), in addition to all the above mentioned attributes of the standard online auction, the seller also specifies a timeshift interval (30), which determines the closing portion of the predetermined auction period (10). As shown on FIG. 1B, the timeshift interval (30) shortens the necessary bidding period (20). Following the definition of the necessary bidding period (20), the bidders who are interested in an auctioned item are required to place at least a single bid before the countdown of the timeshift interval (30) starts. The bidding process continues until the end of the predetermined auction period (10). The highest bidder at the close of the auction, who had placed at least a single bid before the countdown of the timeshift interval (30) started, is the winner of the auction and obtains the item.

From the above comparison, three timeshift auction specific features, which are common for all timeshift auctions, can be noticed: (i) when the timeshift interval is set to zero, the existing fixed time online auction and the corresponding online timeshift auction are the same and the outcome is expected to be the same; (ii) it is not required to have any bids placed during the timeshift interval (30) portion of the predetermined auction period (10); and (iii) at the close of the auction (14), the bidder who had placed highest bid obtains the item, even if he/she had placed only a single bid during the necessary bidding interval (20).

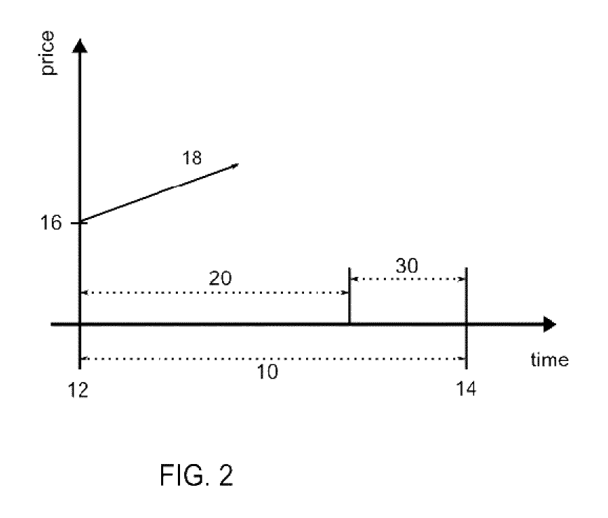

Those skilled in the art will recognize how the introduction of the timeshift interval (30) can modify both forward and reverse online auctions where items are offered for a fixed, predetermined auction period. FIG. 2 illustrates a conceptual diagram of the general form of the forward online timeshift auctions. The seller specifies all the basic required attributes of the forward online timeshift auctions: the predetermined auction period (10), the starting bid (16) and the timeshift interval (30). In addition to these basic required attributes, the seller can also set some of the auction-specific requirements, such as the minimum or reserve price, etc. Bidders drive price up (18) as they attempt to outbid each other. If at the end of the necessary bidding period (20) all the auction-specific requirements are met, the auction continues until the end of the predetermined auction period (10). At the close of the auction (14), the highest bidder, who had placed at least a single bid during the necessary bidding period (20), is the winner of the auction. Thus, as a general rule for all types of timeshift auctions, as long as the minimum bid, reserve price or any other preconditions of a particular type of auction are met during the necessary bidding period (20), the auction continues and the highest bidder at the close of the auction, who had placed at least a single bid before the countdown of the timeshift interval started, obtains the item.

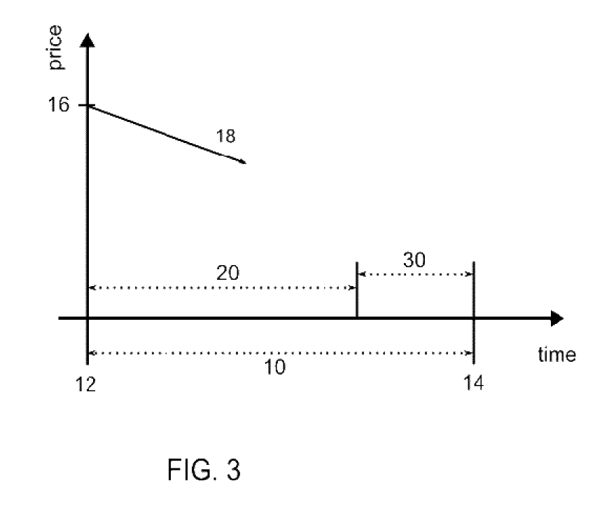

FIG. 3 illustrates a conceptual diagram of the general form of the reverse online timeshift auctions. The reverse auctions are common for auctioning services, items wanted, etc. The seller specifies the basic attributes of the reverse online timeshift auctions: the predetermined auction period (10), the starting bid (16) and the timeshift interval (30). The seller can also set some of the auction-specific requirements, such as the maximum or reserve price, etc. Bidders drive price down (18) as they attempt to outbid each other. If at the end of the necessary bidding period (20) all the auction-specific requirements are met, the auction continues until the end of the predetermined auction period (10). At the close of the auction (14), the lowest bidder who had placed at least a single bid during the necessary bidding period (20) is the winner of the auction.

### Psychology of the Game

There are two big unknown factors in auctions: (i) a number of potential buyers, which is the number of bidders showing their interest in an auctioned item, and (ii) how much interested bidders are willing to pay for it. In addition to knowing these two factors, the sellers would also like to have the auction system that will encourage them to auction their items by realizing the fair price for the auctioned items.

From the description above, two major elements that timeshift auctions introduce can be noticed:

(a) Timeshift auctions eliminate the above mentioned optimal strategy limitation. In the timeshift auctions, this is achieved naturally because the introduced timeshift interval separates the necessary bidding period (20) and the end of the auction (14). Thus, all interested bidders ought to declare their interest in the item by placing their bids before the countdown of the timeshift interval starts.

(b) Timeshift auctions encourage early bidding. Since the interested bidders need to declare their interest before the countdown of the timeshift interval starts, the only information an individual bidder can hide is the highest price he/she is willing to pay for the item. The most effective way to mask this information from others is to place a bid as early as possible when the current price of the item is close to a starting bid set by the seller.

These two major improvements make a task of figuring out the optimal strategy of the timeshift auctions more complex. At the same time, online timeshift auctions bridge some of the most attractive elements of the popular traditional and online auctions, in particular, they provide more accurate information about the potential buyers interested in an item and they are simple and easy to understand. By avoiding optimal strategy limitation and encouraging early bidding, timeshift auctions serve a goal of achieving a fair price of the auctioned item.

### Advantages

From the description above, a number of advantages of some embodiments of timeshift auctions become evident. While there are numerous online auction methods, my invention is superior because it:

encourages early bidding and avoids the optimal strategy restriction,

helps sellers obtain valuable information that can be used for marketing purposes,

is a slight, but qualitative modification of the existing most-popular fixed time auctions,

is simple and easy to understand and described in terms of the existing auctions,

is easy to implement and build.

Although the description above is focused on the simple forms of online fixed time auctions, those skilled in the art will recognize how this method can modify other types of fixed time auctions, such as multiple item “Dutch” auctions, etc. Timeshift auctions can also be expended to have multiple timeshift intervals during a fixed auction period. Thus the scope of the embodiment should not be determined by the specific examples given, but rather the appended claims and their legal equivalents.

I claim:

1. A method for conducting online auctions comprising the steps of:
(a) defining a fixed time period, the predetermined auction period in which the auction on a particular item is to take place,
(b) defining a timeshift interval which determines a closing portion of said predetermined auction period,
(c) selecting a winner of said auction at the end of said predetermined auction period to be the highest bidder who had placed at least a single bid before the countdown of said timeshift interval started.

2. The auction method of claim 1 wherein multiple identical items are offered.

3. The auction method of claim 1 wherein any auction-specific requirements, such as the minimum or reserve price requirement, etc. have to be met before the countdown of said timeshift interval starts.

4. The auction method of claim 3 wherein multiple identical items are offered.

5. A method for conducting reverse online auctions comprising the steps of:
(a) defining a fixed time period, the predetermined auction period in which the auction on a particular item is to take place,
(b) defining a timeshift interval which determines a closing portion of said predetermined auction period,
(c) selecting a winner of said auction at the end of said predetermined auction period to be the lowest bidder who had placed at least a single bid before the countdown of said timeshift interval started.

6. The auction method of claim 5 wherein multiple items are offered.

7. The auction method of claim 5 wherein any auction-specific requirements, such as maximum or reserve price requirement, etc. have to be met before the countdown of said timeshift interval starts.

8. The auction method of claim 7 wherein multiple items are offered.
